(19) United States
(12) Patent Application Publication
(10) Pub. No.: US 2026/0310748 A1
(43) Pub. Date: Oct. 8, 2026

(54) SYSTEMS AND METHODS TO EFFICIENTLY PROCESS MATRICES IN LLMS USING SINGULAR VALUE DECOMPOSITION

(71) Applicant: Cornami, Inc., Dallas, TX (US)

(72) Inventors: Fa-Long Luo, Dallas, TX (US); Paul Master, Dallas, TX (US)

(21) Appl. No.: 19/173,601

(22) Filed: Apr. 8, 2025

(51) Int. Cl. G06F 17/16

(52) U.S. Cl. CPC G06F 17/16

(57) ABSTRACT

A method and system for reducing computation of matrices in an application such as a large language model in ciphertext format and plaintext format. The example method uses singular value decomposition to zero out values in a matrix such as a weight matrix to produce a reduced matrix. The reduced matrix is used to determine two smaller matrices, which are multiplied with each other and the reduced weight matrix. Since multiplication and memory access are performed on smaller matrices, computational resources required are less in the example method. The example method thus reduces the complexity of matrix based calculations.

### TECHNICAL FIELD

The present disclosure relates generally to training large language model applications and executing interference operations. More particularly, aspects of this disclosure relate to techniques to efficiently process matrices in LLM operations using singular value decomposition in encrypted ciphertext format and plaintext format.

### BACKGROUND

Large Language Models (LLMs), also known as generative Artificial Intelligence (Gen AI), transformers, or Natural Language Processing (NLP), have now become, in a very short space of time, a foundational artificial intelligence technique. They provide human level intelligence across the knowledge base they are trained upon. The key metric, which is proportional to the amount of knowledge they hold, is the number of parameters or weights that they hold. Very large models start in the low billions of parameters moving up to the low trillions of parameters. The training sets on the largest models can comprise the entirety of the accessible internet.

Using existing pretrained LLMs as a starting point it is possible to perform additional training using very specific knowledge to produce LLMs that are experts in the narrow knowledge domain. This process of taking an existing LLM and continuing its training is known as fine-tuning. Fine tuning involves taking a pre-existing model that has been trained on a large dataset, such as a language model like GPT-3, and refining it for a specific task or domain. During fine-tuning, the model is further trained on a smaller, domain-specific dataset. This process adapts the model parameters to the nuances of the target task, thus improving performance and making the model more capable in handling specific tasks. Fine-tuning is a cost-effective and efficient way to leverage the knowledge learned by a pre-trained model while tailoring the model to specific applications, reducing the need for extensive training from scratch. Since the most compute intensive operations have already been performed in the development of the initial model, the fine-tuning process only requires a small percentage of the weights to be modified to incorporate the additional, expert level information. Typically, only 1/100 to 1/10,000 of the exiting parameters need to be modified. This has proven to be a game-changer in many information processing tasks, allowing for rapid development of domain specific AI solutions with high accuracy and applicability.

Training and inference are two crucial phases in the lifecycle of Large Language Models (LLMs), such as Llama-3. These models are pre-trained on vast corpora of text data and then fine-tuned for specific tasks before they can be effectively deployed for real-world applications.

The training of LLMs is a computational resource-intensive process that typically involves two main steps: pre-training, which requires the majority of the computational resources and fine-tuning. During pre-training, the model is exposed to a massive amount of text from the internet, learning to predict the next word in a sentence. This helps the model acquire a vast amount of world knowledge and linguistic patterns. The training process involves updating billions of model parameters using powerful computational resources, typically state of the art NVIDIA GPUs, which can take days, weeks or even months to complete. Following pre-training, fine-tuning is performed on a narrower dataset with labeled examples for a specific task, such as a company's intellectual property. Fine-tuning adapts the model parameters to the target task, making it more effective and contextually relevant. Fine-tuning is a critical step that tailors the LLM for practical applications taking from human level to expert level intelligence.

Once an LLM has been trained and fine-tuned, the trained and fine-tuned LLM can be used for inference, which involves making predictions or generating text for specific tasks. During inference, input data, typically in the form of text, is fed into the model. The model processes the input, generates output, and provides predictions or text generation. Inference can be performed both in real-time applications and non-real-time applications. Real-time applications are sensitive to latency, such as chatbots, language translation services, content generation, and more. Non-real-time applications, such as batch processing of document, information, software, hardware designs and the like are not sensitive to latency. The LLMs are deployed on high computational powered cloud servers in data centers, or in a private data center of a company, which enables deployment to all the employees of the company, software as a service to paying customers, or even access on the general Internet. Inference with LLMs is revolutionizing industries by automating tasks that previously required a human expert.

The issue with producing expert-level fine-tuned LLM is that they, by definition, must include valuable proprietary information. The entirety of expertise, intellectual property, knowledge base, trade secrets, and confidential information of a company from inception to the present time can be incorporated into a fine-tuned LLM. Thus, there are four existing problems with fine-tuned LLMs. Two of these problems are on the inference portion of the fine-tuned LLM. First, from the perspective of the owner of the fine-tuned LLM model, the theft of one of these fine-tuned LLM is catastrophic. The LLM can enable competitors to produce products or offer services that compete with the owners'business. Alternatively, if the LLM is simply released on the Internet, the revenue of the original company may be driven to zero. Thus, there is a need to prevent the use by unauthorized third parties of a fine-tuned LLM.

Second, a user of these LLMs is providing queries to the fine-tuned LLM and receiving results from these queries. The queries may contain intellectual property of the user and the answers to these queries may contain new and novel intellectual property that the owner of the fine-tuned LLM now has access to. There is a need to prevent the leakage of intellectual property of a user into the LLM from the queries as well as protect any new and novel intellectual property in the responses form the LLM.

The training portion of the fine-tuned LLM also presents two problems. First, the training of the fine-tuned parameters is typically performed using plain-text or human readable data. The fine-tuned parameters must be protected from theft or disclosure by either external parties or even internal employees during this entire process. There is a need to protect against the theft of the plaintext LLM data as it is undergoing fine-tuning. Second, the information that is used for the fine-tuning process may be highly sensitive, proprietary, classified or protected under privacy laws such as the European GDPR rules or the HIPPA rules in the US.

Thus, current solutions to these problems require encryption of the weights of the LLM as well as the inputs to the LLMs. The encryption protects the valuable weights as well as input inquires and responses.

Currently, encryption techniques relate to public/private key mechanisms that require an intensive level of computing power to brute force solve the encryption. Such systems are currently secure because of the corresponding intensive level of computing power necessary to solve such encryption. However, with the advent of potential quantum computers, standard encryption techniques may be vulnerable to being solved by a quantum computer. Thus, new types of quantum secure encryption have been proposed, such as fully homomorphic encryption (FHE). FHE allows computations on ciphertext without having to perform decryption. This allows delegation of sensitive data analysis computations on encrypted data. The FHE allows computations such a Boolean operation, Integer arithmetic operation, Floating-point arithmetic operation on ciphertext without decryption. Thus, sensitive data analysis (computations) may be performed on encrypted data without ever decrypting the data. There are several open-source frameworks of fully homomorphic encryption one such framework is the Concrete library that implements the Fully Homomorphic Encryption over the Torus (TFHE) procedure. A second such framework is the OpenFHE framework which supports multiple schemes including BGV, BFV, CKKS, TFHE, and FHEW.

The Concrete library is an open-source library developed in Rust that builds on the state-of-art TFHE cryptosystem. The Concrete library provides a user friendly interface making FHE easy to integrate. The Concrete library deals with inputs of arbitrary format and comes with an extensive set of operations for manipulating ciphertexts, including a programmable bootstrapping process. Learning With Errors (LWE) is a quantum robust method of cryptography applicable to FHE that is conjectured to be hard to solve, and thus is useful in cryptography.

Currently TFHE/Concrete Boolean operations require a series of bootstraps to eliminate noise from the computational routines performed on ciphertext. Bootstrapping is a computationally expensive process that involves performing a large number of transforms and matrix multiplications. Such transforms and matrix computations require a large amount of processing power for the necessary bootstrapping required for FHE supporting operations. This is especially the case when the matrices to be multiplied are large. The large number of operations for the bootstrap requires significant computational resources and time and thus impedes efficient encryption.

There is a need to implement an efficient encrypted execution of an LLM in training and inference operation. There is another need for a process of more efficiently executing LLM operations by reducing the complexity of required calculations.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a method to reduce computation of a matrix by a computer processor is disclosed. A weight matrix having a first dimension and a second dimension is determined. Elements of the weight matrix are eliminated by singular value decomposition to produce a reduced weight matrix of a third dimension by the third dimension by the computer processor. A first reduced matrix of the first dimension and the third dimension is determined. A second reduced matrix of the second dimension and the third dimension is determined. The reduced weight matrix is multiplied by the first reduced matrix and the second reduced matrix to solve the weight matrix via the processor.

A further implementation of the example method includes multiplying the first reduced matrix and the second reduced matrix by an input to produce a matrix output from the solved weight matrix. Another implementation is where the weight matrix is ciphertext and the input is plaintext. Another implementation is where the weight matrix is plaintext and the input is plaintext. Another implementation is where the ciphertext is generated via encryption performed via a Fully Homomorphic Encryption (FHE) process. Another implementation is where the weight matrix is one of a key matrix, query matrix or a value matrix. Another implementation is where the output of the multiplications of the reduced weight matrix is part of inferring a large language model. Another implementation is where the output of the multiplications of the reduced weight matrix is part of training a large language model. Another implementation is where the example method includes adding a reduced scale version of the weight matrix to the results of multiplying the reduced weight matrix by the first reduced matrix and the second reduced matrix to perform quantization.

According to certain aspects of the present disclosure, a computer system configured to reduce computation of a matrix is disclosed. A memory stores a weight matrix having a first dimension and a second dimension. A processing unit is coupled to the memory. The processing unit is operable to eliminate elements of the weight matrix by singular value decomposition to produce a reduced weight matrix of a third dimension by the third dimension. The processor is operable to determine a first reduced matrix of the first dimension and the third dimension and determine a second reduced matrix of the second dimension and the third dimension. The processor multiplies the reduced weight matrix by the first reduced matrix and the second reduced matrix to solve the weight matrix.

A further implementation of the example computer system is where the processing unit includes a plurality of configurable processing cores interconnected with each other. At least some of the processing cores are configured to performing determining and multiplying. Another implementation is where the computer system includes an input interface coupled to the processing unit. The input interface accepts an input. The processing unit is operable to multiply the input by the first reduced matrix and the second reduced matrix to produce a matrix output from the solved weight matrix. Another implementation is where the weight matrix is ciphertext and the input is plaintext. Another implementation is where the weight matrix is plaintext and the input is plaintext. Another implementation is where the processing unit is operable to generate ciphertext via encryption performed via a Fully Homomorphic Encryption (FHE) process. Another implementation is where the weight matrix is one of a key matrix, query matrix or a value matrix. Another implementation is where the output of the multiplications of the reduced weight matrix is performed by the processing unit in inferring a large language model. Another implementation is where the output of the multiplications of the reduced weight matrix is performed by the processing unit in training a large language model. Another implementation is where the processing unit is operable to add a reduced scale version of the weight matrix to the results of multiplying the reduced weight matrix by the first reduced matrix and the second reduced matrix to perform quantization.

According to certain aspects of the present disclosure, a non-transitory computer-readable medium having machine-readable instructions stored thereon is disclosed. When the instructions are executed by a processor, they cause the processor to determine a weight matrix having a first dimension and a second dimension. The instructions cause the processor to eliminate elements of the weight matrix by singular value decomposition to produce a reduced weight matrix of a third dimension by the third dimension. The instructions cause the processor to determine a first reduced matrix of the first dimension and the third dimension and determine a second reduced matrix of the second dimension and the third dimension. The instructions case the processor to multiply the reduced weight matrix by the first reduced matrix and the second reduced matrix to solve the weight matrix.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be better understood from the following description of exemplary embodiments together with reference to the accompanying drawings, in which:

FIG. 1A is a diagram of a chip having four dies each having multiple processing cores;

FIG. 1B is a simplified diagram of one of the dies on the chip shown in FIG. 1A;

FIG. 2A is a block diagram of the array of cores in the die in FIG. 1B;

FIG. 2B is a three-dimensional view of the array of cores in the die in FIG. 1B;

FIG. 3A is a block diagram of one of the cores in the example core array in FIG. 2B;

FIG. 3B is a set of configurations for multiple cores in the example core array in FIG. 2B;

FIG. 4A is a block diagram of basic processing for an example LLM;

FIG. 4B is a detailed block diagram of the attention module in FIG. 4A;

FIG. 5A is a mathematical representation of the example method of matrix reduction;

FIG. 5B is a diagram of an example matrix reduction from the representation in FIG. 5A;

FIG. 6A shows the application of the example method in a plaintext implementation based on plaintext matrix multiplication;

FIG. 6B shows the application of the example method in a ciphertext implementation based on ciphertext-plaintext matrix multiplication;

FIG. 7 is a mathematical representation of the example method of matrix reduction in a quantization function;

FIG. 8A shows the application of the example method in a plaintext implementation based on plaintext matrix multiplication in quantization; and

FIG. 8B shows the application of the example method in a ciphertext implementation based on ciphertext-plaintext matrix multiplication in quantization.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward reducing matrix calculations by reducing a matrix into smaller matrices. The example method uses singular value decomposition to zero out values in a matrix such as a weight matrix. The reduced matrix is used to determine two smaller matrices, which are multiplied with each other and the reduced weight matrix. Since the multiplication is performed on smaller matrices, computational resources required are less. This method thus reduces the complexity of matrix based calculations. In relation to LLM functions, this may increase computational efficiency.

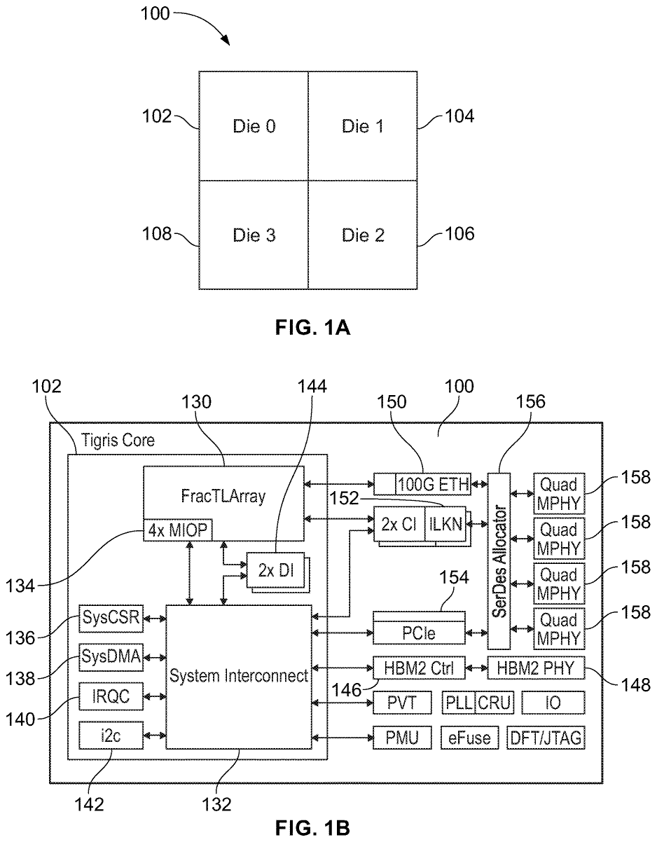

FIG. 1A shows an example chip 100 that is subdivided into four identical dies 102, 104, 106, and 108. Each of the dies 102, 104, 106, and 108 include multiple processor cores, support circuits, serial interconnections and serial data control subsystems. For example, the dies 102, 104, 106, and 108 may each have 4,096 processing cores as well as SERDES interconnection lanes to support different communication protocols. There are die to die parallel connections between the dies 102, 104, 106 and 108. Thus, each of the dies 102, 104, 106, and 108 in this example are interconnected by Interlaken connections. The chip 100 is designed to allow one, two or all four of the dies 102, 104, 106, and 108 to be used. The pins on a package related to un-used dies are left unconnected in the package or the board. The dies are scalable as additional chips identical to the chip 100 may be implemented in a device or a circuit board. In this example, a single communication port such as an Ethernet port is provided for the chip 100. Of course, other ports may be provided, such as one or more ports for each die.

FIG. 1B is a block diagram of one example of the die 102. The die 102 includes a fractal array 130 of processing cores. The processing cores in the fractal array 130 are interconnected with each other via a system interconnect 132. The entire array of cores 130 serves as the major processing engine of the die 102 and the chip 100. In this example, there are 4096 cores in the fractal array 130 that are organized in a grid.

The system interconnection 132 is coupled to a series of memory input/output processors (MIOP) 134. The system interconnection 132 is coupled to a control status register (CSR) 136, a direct memory access (DMA) 138, an interrupt controller (IRQC) 140, an I2C bus controller 142, and two die to die interconnections 144. The two die to die interconnections 144 allow communication between the array of processing cores 130 of the die 102 and the two neighboring dies 104 and 108 in FIG. 1A.

The chip includes a high bandwidth memory controller 146 coupled to a high bandwidth memory 148 that constitute an external memory sub-system. The chip also includes an Ethernet controller system 150, an Interlaken controller system 152, and a PCIe controller system 154 for external communications. In this example each of the controller systems 150, 152, and 154 have a media access controller, a physical coding sublayer (PCS) and an input for data to and from the cores. Each controller of the respective communication protocol systems 150, 152, and 154 interfaces with the cores to provide data in the respective communication protocol. In this example, the Interlaken controller system 152 has two Interlaken controllers and respective channels. A SERDES allocator 156 allows allocation of SERDES lines through quad M-PHY units 158 to the communication systems 150, 152 and 154. Each of the controllers of the communication systems 150, 152, and 154 may access the high bandwidth memory 148.

In this example, the array 130 of directly interconnected cores are organized in tiles with 16 cores in each tile. The array 130 functions as a memory network on chip by having a high-bandwidth interconnect for routing data streams between the cores and the external DRAM through memory IO processors (MIOP) 134 and the high bandwidth memory controller 146. The array 130 functions as a link network on chip interconnection for supporting communication between distant cores including chip-to-chip communication through an “Array of Chips” Bridge module. The array 130 has an error reporter function that captures and filters fatal error messages from all components of array 130.

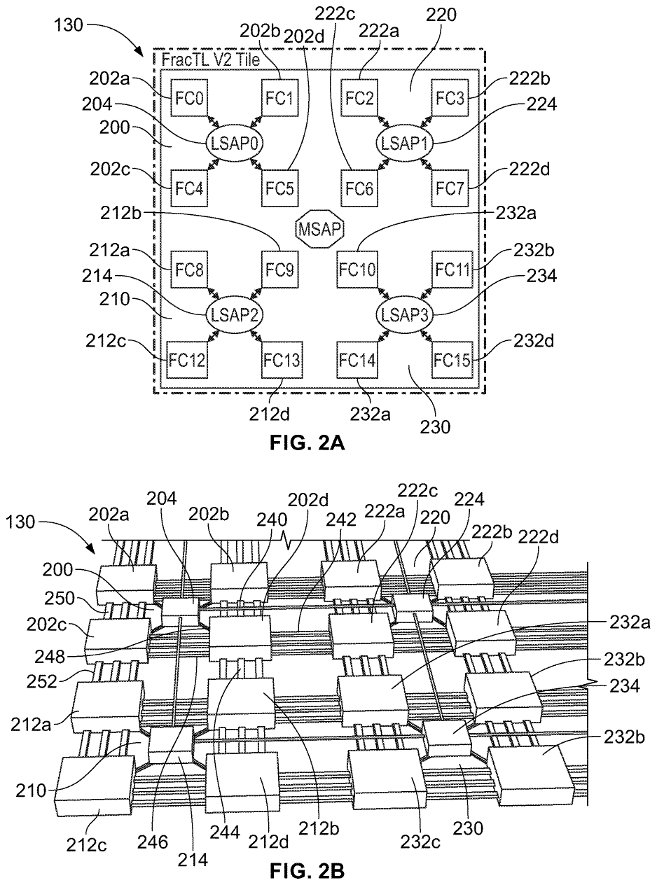

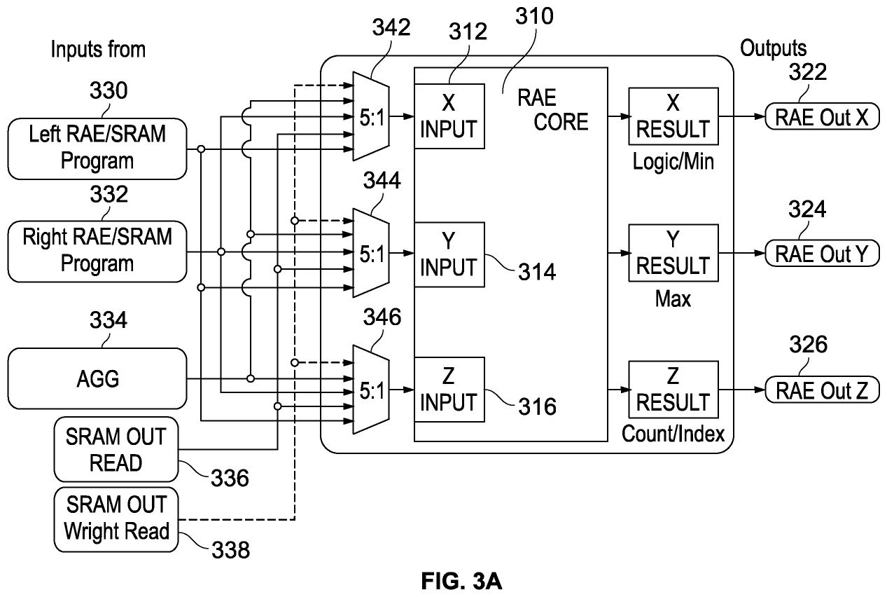

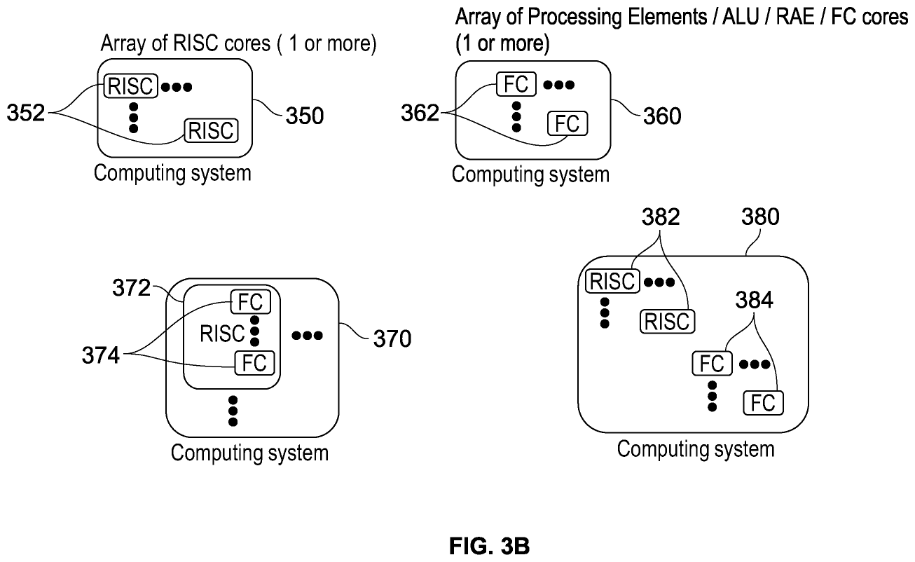

FIG. 2A is a detailed diagram of the array of cores 130 in FIG. 1B. FIG. 2B is a three-dimensional image of the array of cores 130 in FIG. 2A. The array of cores 130 is organized into four core clusters such as the clusters 200, 210, 220, and 230 shown in FIG. 3A. For example, the cluster 200 includes cores 202a, 202b, 202c, and 202d. Each of the four cores in each cluster 200 such as cores 202a, 202b, 202c, and 202d are coupled together by a router 204. FIG. 3B shows other clusters 210, 220, and 230 with corresponding cores 212a-212d, 222a-222d and 232a-232d and corresponding routers 214, 224, and 234.

As may be seen specifically in FIG. 2B, in this example, each of the cores 202a, 202b, 202c, and 202d has up to four sets of three interconnections [L, A, R]. For example, a core in the center of the array such as the core 202d includes four sets of interconnections 240, 242, 244, and 246 each connected to one of four neighboring cores. Thus, core 202b is connected to the core 202d via the interconnections 240, core 222c is connected to the core 202d via the interconnections 242, core 212b is connected to the core 202d via the interconnections 244, and core 202c is connected to the core 202d via the interconnections 246. A separate connector 248 is coupled to the wire router 204 of the cluster 200. Thus, each core in the middle of the array has four sets of interconnections, while border cores such as the core 202c only have three sets of interconnections 250, 252, and 246 that are connected to respective cores 202a, 212a, and 202d. In order to configure the cores of the example array 130 in FIG. 2A, the inputs of certain blocks may be changed to configure blocks for one of the three different function blocks. The functions may be configured by simply changing the inputs of the processing cores.

In order to configure the cores of the example array 130 in FIG. 1B, the inputs of certain blocks may be changed to configure blocks for one of the three different function blocks. The functions may be configured by simply changing the inputs of the processing cores. FIG. 3A shows a block diagram of an example processing core 300 that includes a reconfigurable arithmetic engine (RAE) 310. The RAE 310 may be configured and reconfigured to perform relevant mathematical routines such as matrix multiplications, point wise multiplication and nonlinear functions, such as layer normalization and a Softmax function, required in private LLM. The RAE 310 includes input reorder queues, a multiplier shifter-combiner network, an accumulator and logic circuits. The RAE 310 operates in several modes, such as operating as an ALU, and includes a number of floating point and integer arithmetic modes, logical manipulation modes (Boolean logic and shift/rotate), conditional operations, and format conversion. The RAE 310 includes three inputs 312, 314, and 316 and three outputs 322, 324, and 326. The RAE 310 receives the output data from a program executed by another RAE 330 and output data from another program executed by another RAE 332. An aggregator (AGG) 334 provides an output of aggregated data from different sources to the RAE 310. A memory read output 336 and a memory write output 338 also provide data to the RAE 310. The memory outputs 336 and 338 provide access to a memory such as an SRAM that stores operand data, and optionally may also store configurations or other instructions for the RAE 310.

Each of the output data of the RAE 330, RAE 332, aggregator 334, memory read output 336 and the memory write output 338 are provided as inputs to three multiplexers 342, 344, and 346. The outputs of the respective multiplexers 342, 344, and 346 are coupled to the respective inputs 312, 314, and 316 of the RAE 310.

There are two versions of configuration of computational cores which can dynamically switch from one type to the other. A set of cores may be configured as a full RISC-V processor with associated SRAM able to execute traditional control flow programs as a function representing the computation within a dataflow node. RISC-V for Legacy code is supported by configuring multiple cores under software control. This may be used to produce software GPUs or other types of cores from the multiple cores. The processing cores such as the FracTLcores offered by Cornami are an efficient set of transistors for streaming data driven workloads, with a dynamic programming scheduler such as the TruStream programming scheduler offered by Cornami and memory, created from a set of RAE Cores. In this example, the FracTLcores can scale up to 64,000,000 cores across chips and systems at near linear scale. Combining the aspects of both data flow and reconfigurable computing to stream data, this architecture with highly functional computational elements can dynamically scale over many chips. It enables developers to take full advantage of both parallelism and pipelining to minimize processing latency and maximize overall application performance and throughput. The use of the architecture of processing cores results in reduction in processing cost. The cores may employ a data-flow programming model resulting in a 5× reduction in processing cost. A data-defining-function computation for the cores may result in a 6× reduction in processing cost. A data Read/Write with a Tensor pattern applied to the cores may result in a 6× reduction in processing cost.

FIG. 3B is a diagram of four configurations 350, 360, 370, and 380 of the array of cores in FIG. 1B as either a RISC-V processor or a specialized ALU internal module. The configurations 350, 360, 370, and 380 can dynamically switch from one type to the other by reconfiguring some or all of the computational cores in the configurations. The first configuration 350 is a set of cores configured as a full RISC processor with associated SRAM able to execute traditional Control Flow programs as a function representing the computation within a dataflow node. In this example, the RISC processor includes sixteen separate cores 352. Another configuration 360 is sixteen independently reconfigurable and programmable ALUs, that are each cores 362 (termed FracTLcores® available from Cornami in this example). Each of the cores 362 have associated SRAM supporting multiple simultaneous integer and floating point computations of up to 128-bits. The configuration 360 thus is a set of cores that are configured as individual FracTLcores. The configuration 370 includes one or more RISC cores 372 that are a set of sixteen cores in this example. The RISC core 372 can have additional individual or multiple FracTLcores 374 incorporated within them to accelerate specific RISC functions. Alternatively, the additional cores 374 may be designated for data path/arithmetic acceleration, enhancing ALU performance.

Thus, to implement a standard 64 bit RISC processor such as the RISC-V processor in this example, sixteen cores are configured to become the RISC-V. Optional additional cores may be added to the configuration to provide hardware acceleration to math operations performed by the RISC. For example, a normal RISC processor does not have hardware to perform a cosine function. Thus, an additional core may be added and configured to perform a hardware cosine operation. This enhances the ISA instruction set of the RISC processor by adding the hardware accelerated cosine function that may be accessed by the RISC processor. The configuration 380 has a set of cores that is configured into two individual groupings of cores configured as RISC processors 382 and cores that are configured as ALUs (e.g., FracTLcores) 384.

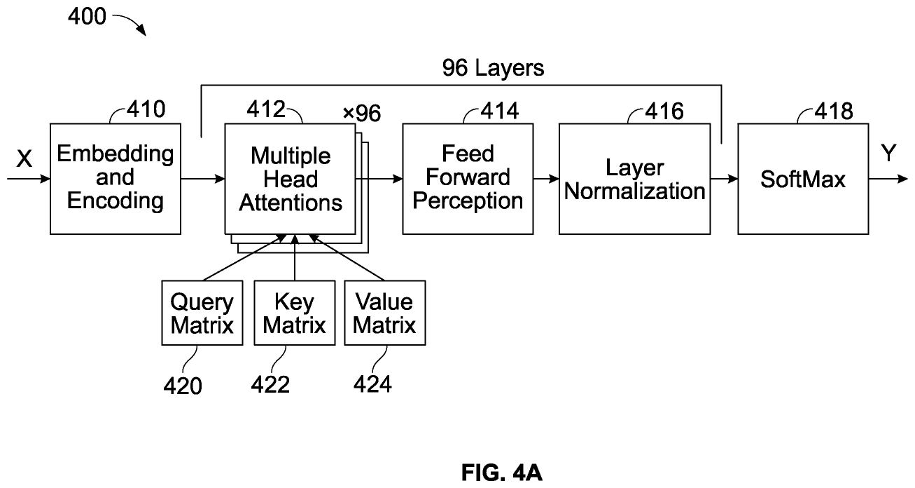

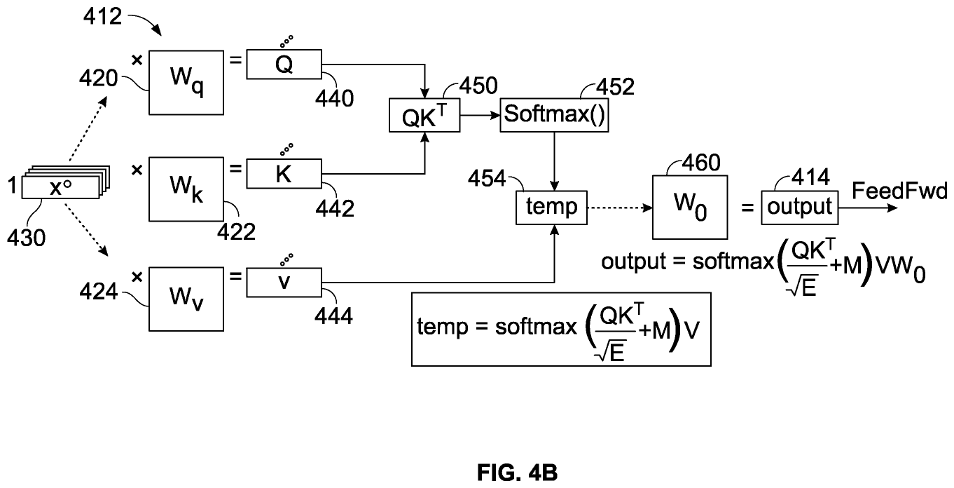

FIG. 4A is a diagram of a system 400 for executing an LLM. The system 400 may be configured from the array of cores shown in FIG. 2A-2B or 3A-3B. An LLM may be considered as a nonlinear mapping from the input X (a query) and to output Y (a response) by performing the following major processing blocks shown in FIG. 4. The major processing blocks thus include an Embedding and Encoding block 410, multiple Head Attention blocks 412, a Feed Forward Perceptron 414, a Layer Normalization block 416 and a Softmax function block 418. The Embedding and Encoding block 410 is a pre-processing unit which mainly performs the matrix multiplications between the input matrix and the corresponding weight matrices. The multiple Head Attentions 412 perform multiple matrix multiplications according to three weight matrices called a Query Weight Matrix 420, a Key Weight Matrix 422, and a Value Weight Matrix 424, respectively. The Feed Forward Perceptron layers 414 constitute a conventional feedforward neural network having at least one hidden layer. The Layer Normalization block 416 simply normalizes each input. The Softmax function block 418 is an activation function that scales numbers/logits into probabilities.

The output of an LLM can uniquely be generated by all the pre-determined weight matrices and its inputs. These weight matrices can be obtained during an off-line training stage. During an inference stage, the LLM simply performs all the above matrix multiplications and corresponding nonlinear functions such as layer normalization and Softmax operations. Different LLMs have different parameter sizes (the total element number of the weight matrices), which mainly depend on the numbers of attention heads and number of LLM layers. For example, GPT-3 has 96 heads and 96 layers and hence there are about 175 billion parameters (elements of weight matrices) in total.

FIG. 4B is a detailed diagram of a known system to execute the head attentions 112 of the LLM system 400 in FIG. 4A. An input 430 is derived from the embedded and encoded query 410 in FIG. 4A. The input 430 is fed to perform plaintext-plaintext matrix multiplication (PPMM) with the Query weight Matrix 420, the Key weight Matrix 422, and the Value weight Matrix 424 to produce a query matrix 440, a key matrix 442, and a value matrix 444. The query matrix 440 and the key matrix 442 generate a new output matrix 450 by performing a PPMM. The output matrix 450 of the PPMM is then provided to a Softmax function 452. The output of the Softmax function 452 is fed into a temp operation 454 together with the value matrix 444. Through a PPMM, the output of temp operation 454 multiplies with a weight matrix 460 and then is sent to the feedforward neural network 414. If the input 430 is encrypted or the weights in the matrices 420, 422, and 424 are encrypted, the information is more secure, but additional computational resources such as for performing bootstrapping are required due to the ciphertext involved.

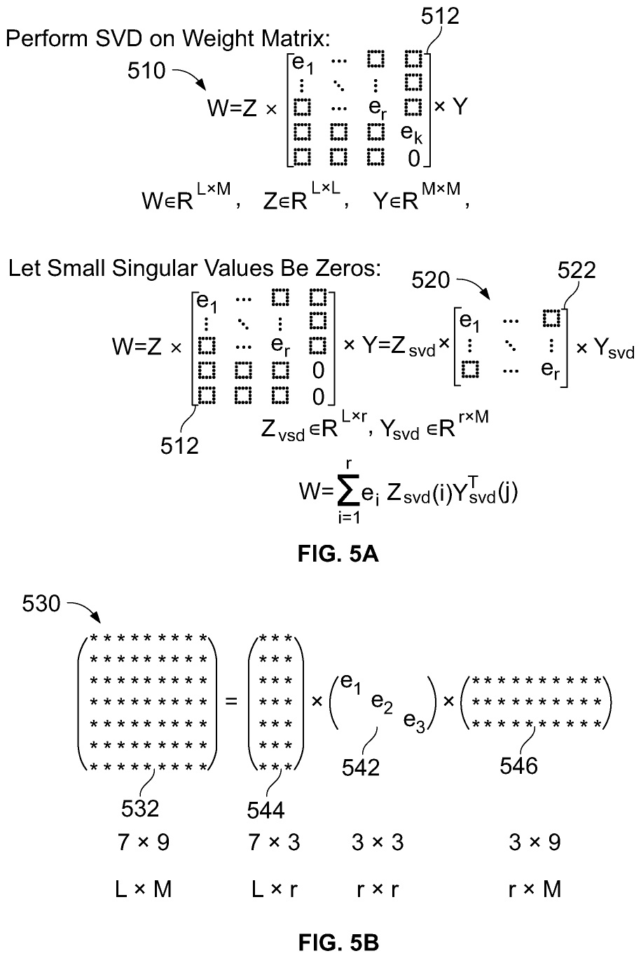

FIG. 5A shows the mathematical representation of one example method of matrix reduction based on singular value decomposition used to determine the matrices 420, 422, and 424 in FIG. 4B. FIG. 5A is a representation 510 that shows that the SVD of a matrix W such as a weight matrix 512 with L×M consists of three matrices: namely, Z∈R^{L×L}, Y∈R^{M×M} and a diagonal matrix whose elements are the singular values eᵢ (i=1,2, . . . , r) of the matrix W.

In the example method, the small singular values in the weight matrix 512 are assigned zero. The threshold to assign small singular values may be predetermined but one common example is the tenth of the average value of all singular values in the matrix. Assuming that there are r values in the matrix that are greater than small singular values, a reduced matrix of r×r dimensions may be obtained. Thus, as shown in a modified equation 520, the multiplication of a reduced matrix 522 of r×r is through modified singular value decomposition matrices Y_{svd} and Z_{svd}. The singular value decomposition matrices are L×r and r×M in size.

FIG. 5B shows a diagram 530 of reduced matrices according to the mathematical expressions in FIG. 5A. In this example, the Parameters for Memory Accessing using the example method may be expressed as follows:

$$Before SVD : LM$$

$$After SVD : r ( L + M )$$

$$Computational saving : \frac{r ( L + M )}{LM}$$

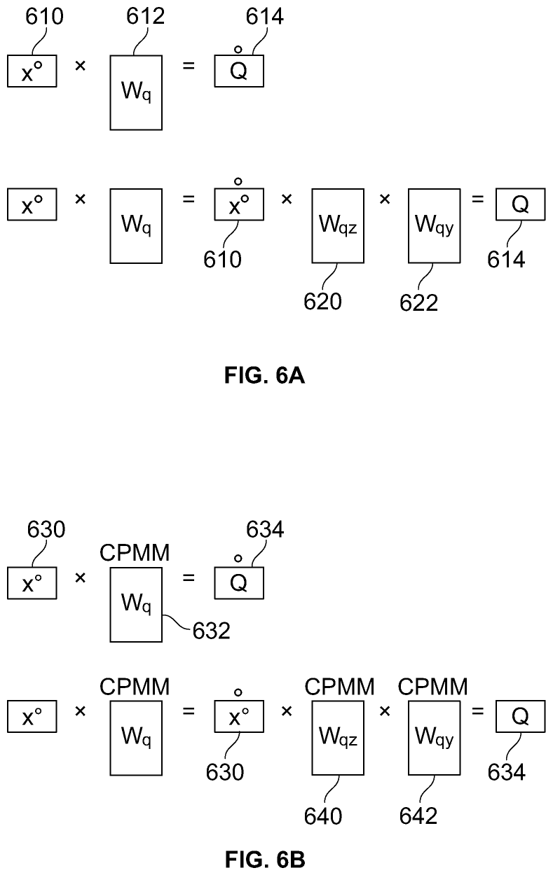

Thus, if r is L/3, there would be 30% savings in memory accessing by the example method. Thus, in this example, L is 7, M is 9, and r is 3. Thus, before SVD, memory accessing of an example weight matrix 532 is 63 (7×9). After performing SVD on the values, memory accessing is 48 (3×(7+9)) from the decomposition matrices and reduced weight matrix 522. As shown in the diagram 530, the initial weight matrix 532 is a 7×9 matrix. The equivalent is a reduced SVD matrix 542 (3×3) multiplied by a Z decomposition matrix 544 of 7×3 dimension and a Y decomposition matrix 546 of 3×9 dimension. Moreover, the 3×3 diagonal matrix 542 could be absorbed into the Z decomposition matrix 544 and become a new matrix with 7×3 elements as shown in the matrix W_{qz} in FIG. 6A.

FIG. 6A shows the application of the example method in a plaintext implementation based on plaintext matrix multiplication. FIG. 6A shows an input 610, (x) that is multiplied by a weight matrix 612 (W_{q}) to produce an output 614, Q. The initial equation may be reduced to multiplying the input 610 by smaller matrices W_{qz} and W_{qy} as shown as matrices 620 and 622. Moreover, an example reduced 3×3 diagonal matrix as explained in FIG. 5B could be absorbed into the matrix Z and become a new matrix with 7×3 elements as shown in the matrix 622 (W_{qz}) in FIG. 6A. The memory and multiplication savings may be expressed as follows:
Before the example method: x∈R^{n×L}, W_{q}∈R^{L×L}, Multiplications of: nL²
After applying the example method: W_{qz}∈R^{L×r}, W_{qy}∈R^{r×L}, Multiplications of: 2nLr
The savings may thus be expressed as:

$$\frac{2 r}{L}$$

The method in FIG. 6A may be applied in a ciphertext implementation based on ciphertext plaintext matrix multiplication for the initial matrix. FIG. 6B shows the method in FIG. 6A applied for ciphertext. FIG. 6B shows an input 630, (x) that is multiplied by a ciphertext-plaintext multiplication weight matrix 632 (W_{q}) to produce an output 634, Q in a ciphertext format. The initial equation may be reduced to multiplying the input 630 by smaller ciphertext-plaintext multiplication matrices W_{qz} and W_{qy} as shown as matrices 640 and 642. As explained above, the weight matrix 632 is reduced by singular value decomposition to a reduced weight matrix. The reduced matrix is absorbed into one of the smaller matrices to produce the matrix 642. The matrix 642 is then multiplied by the reduced matrix 640 to produce the equivalent of the weight matrix 632 to be multiplied by the input 630. Since there are relatively less complex multiplication operations for the smaller ciphertext plaintext multiplication submatrices 640 and 642, the example method provides the output 634 more efficiently.

Thus, the first known result is determined from one ciphertext-plaintext matrix multiplication with a very large weight matrix 632. Applying the example method results in two ciphertext-plaintext matrix multiplications (CPMM) with smaller matrices 640 and 642. Similar to the plaintext version in FIG. 6A, the use of smaller size CPMMs may greatly reduce the complexity of calculation in comparison with calculation of a large size CPMM. On the other hand, because the complexity of a CPMM depends on how a FHE algorithm encodes and packs all these matrices, the savings will depend on which specific FHE algorithm is used in encryption. An additional advantage is reducing boot strapping due to the norm of the singular matrix W_{qy} being bounded, that is, ∥W_{qy}(i)∥=1,i=1, . . . r, which could be used to reduce the noise growth and model growth resulted from the CPMM.

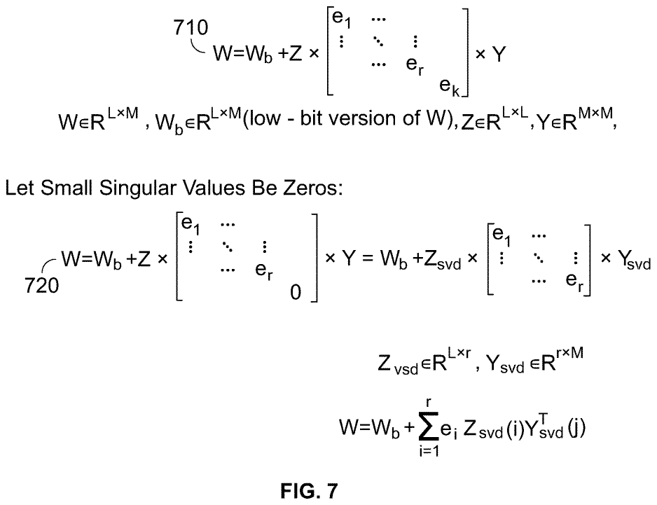

Another technique may be combination of the example method with quantization. This involves the addition of another matrix. FIG. 7 shows a first equation 710 that includes a weight matrix 712 of dimensions L×M that is multiplied by a vector Z. The result from that multiplication is multiplied by a vector Y. An additional matrix 714 (W_{b}) is a low bit version of the weight matrix W, which is added to the result of the matrix multiplication.

In the example method, the small singular values in the weight matrix 712 are assigned zero. Assuming that there are r values in the matrix that are greater than small singular values, a reduced matrix of r×r dimensions may be obtained. Thus, as shown in a modified equation 720, the multiplication of a reduced matrix of r×r is through modified singular value decomposition vectors Y_{svd} and Z_{svd}. The singular value composition vectors are L×r and r×M in size. The evaluation of these is explained above in relation to the example method. The equivalent matrix may then be added to the low bit additional matrix.

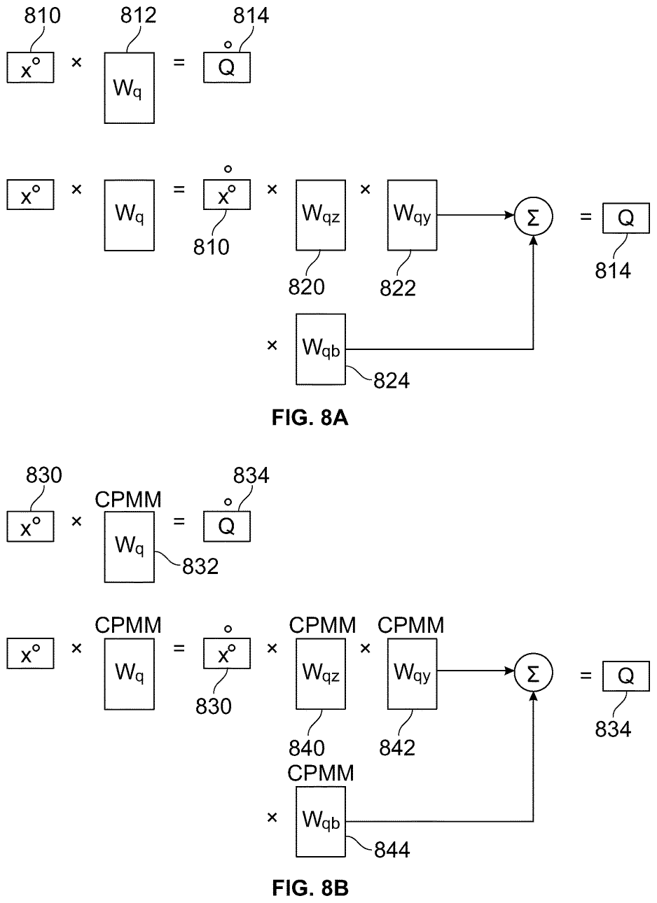

FIG. 8A shows the application of the example method in a plaintext implementation based on plaintext matrix multiplication. FIG. 8A shows an input 810, (x) that is multiplied by a matrix 812 (W_{q}) to produce an output 814, Q. The initial equation may be reduced to multiplying the input 810 by smaller matrices W_{qz} and W_{qy} as shown as matrices 820 and 822 where the smaller matrix W_{qz} has absorbed the r×r diagonal matrix. The input 810 is also multiplied by a low bit quantization matrix 824 (W_{qb}). The results of the multiplication of the input 810 by the smaller matrices 820 and 822 are added to the results of the multiplication of the input 810 by the quantization matrix 824. The overall summarized result is the equivalent of the output 814 but the complexity is much reduced because of the use of low-bit matrix (W_{qb}) and smaller matrices W_{qz} and W_{qy}.

The method in FIG. 8A may be applied in a ciphertext implementation based on ciphertext plaintext matrix multiplication for the initial matrix. FIG. 8B shows the method in FIG. 8A applied for a ciphertext application. FIG. 8B shows an input 830, (x) that is multiplied by a ciphertext-plaintext multiplication matrix 832 (W_{q}) to produce an output 834, Q in a ciphertext format. The initial equation may be reduced to multiplying the input 830 by smaller ciphertext-plaintext multiplication matrices W_{qz} and W_{qy} as shown as matrices 840 and 842. The input 830 is also multiplied by a low bit quantization ciphertext-plaintext matrix 844 (W_{qb}). The results of the multiplication of the input 830 by the smaller matrices 840 and 842 are added to the results of the multiplication of the input 810 by the quantization matrix 844. Since there is relatively less complex multiplication operations for the smaller ciphertext plaintext multiplication submatrices 840 and 842, the example method provides the output 834 more efficiently.

Thus, the first known result is determined from one ciphertext-plaintext matric multiplication with a very large matrix. Applying the example method results in two ciphertext-plaintext matrix multiplications with smaller matrices. The savings will depend on the specific FHE algorithm. Similar to the plaintext version in FIG. 8A, the use of a smaller size CPMM may greatly reduce the complexity in comparison with large size CPMM. On the other hand, because the complexity of a CPMM depends on how a FHE algorithm encodes and packs all these matrices, the savings resulted from this example method will also depend on which specific FHE algorithm is used in encryption. An additional advantage is reducing bootstrapping due to that the norm of singular matrix W_{qy} being bounded, that is, ∥W_{qy}(i)∥=1,i=1, . . . r, which could be used to reduce the noise growth and model growth in CPMM.

The above described example matrix reduction method may be implemented on any suitable hardware or software. For example, a computer system may be configured to reduce computation of a matrix. The computer system may include a memory storing a weight matrix. A processing unit may be coupled to the memory. The example processing unit may be any suitable processor. However, in this example, the computer system may be a configurable computer system based on the array of cores in FIGS. 2A-2B. The cores may be configured to performed the matrix methods disclosed herein.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables the hardware to perform specific function; software stored on a non-transitory computer-readable medium; or a combination thereof. For example, the example matrix reduction methods may be embodied in a non-transitory computer-readable medium having machine-readable instructions stored thereon, which when executed by a processor, cause the processor to perform the example matrix reduction methods.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A method to reduce computation of a matrix by a computer processor, the method comprising:
determining a weight matrix having a first dimension and a second dimension;
eliminating elements of the weight matrix by singular value decomposition to produce a reduced weight matrix of a third dimension by the third dimension by the computer processor;
determining a first reduced matrix of the first dimension and the third dimension;
determining a second reduced matrix of the second dimension and the third dimension; and
multiplying the reduced weight matrix by the first reduced matrix and the second reduced matrix to solve the weight matrix via the processor.

2. The method of claim 1, further comprising multiplying the first reduced matrix and the second reduced matrix by an input to produce a matrix output from the solved weight matrix.

3. The method of claim 2, wherein the weight matrix is ciphertext and the input is plaintext.

4. The method of claim 2, wherein the weight matrix is plaintext and the input is plaintext.

5. The method of claim 3, wherein the ciphertext is generated via encryption performed via a Fully Homomorphic Encryption (FHE) process.

6. The method of claim 1, wherein the weight matrix is one of a key matrix, query matrix or a value matrix.

7. The method of claim 6, wherein the output of the multiplications of the reduced weight matrix is part of inferring a large language model.

8. The method of claim 6, wherein the output of the multiplications of the reduced weight matrix is part of training a large language model.

9. The method of claim 1, further comprising adding a reduced scale version of the weight matrix to the results of multiplying the reduced weight matrix by the first reduced matrix and the second reduced matrix to perform quantization.

10. A computer system configured to reduce computation of a matrix, the computer system comprising:
a memory storing a weight matrix having a first dimension and a second dimension; and
a processing unit coupled to the memory, the processing unit operable to:
eliminate elements of the weight matrix by singular value decomposition to produce a reduced weight matrix of a third dimension by the third dimension;
determine a first reduced matrix of the first dimension and the third dimension;
determine a second reduced matrix of the second dimension and the third dimension; and
multiply the reduced weight matrix by the first reduced matrix and the second reduced matrix to solve the weight matrix.

11. The computer system of claim 10, wherein the processing unit includes a plurality of configurable processing cores interconnected with each other, wherein at least some of the processing cores are configured to performing determining and multiplying.

12. The computer system of claim 10, further comprising an input interface coupled to the processing unit, the input interface accepting an input, wherein the processing unit is operable to multiply the input by the first reduced matrix and the second reduced matrix to produce a matrix output from the solved weight matrix.

13. The computer system of claim 12, wherein the weight matrix is ciphertext and the input is plaintext.

14. The computer system of claim 12, wherein the weight matrix is plaintext and the input is plaintext.

15. The computer system of claim 12, wherein the processing unit is operable to generate ciphertext via encryption performed via a Fully Homomorphic Encryption (FHE) process.

16. The computer system of claim 12, wherein the weight matrix is one of a key matrix, query matrix or a value matrix.

17. The computer system of claim 16, wherein the output of the multiplications of the reduced weight matrix is performed by the processing unit in inferring a large language model.

18. The computer system of claim 16, wherein the output of the multiplications of the reduced weight matrix is performed by the processing unit in training a large language model.

19. The computer system of claim 10, wherein the processing unit is operable to add a reduced scale version of the weight matrix to the results of multiplying the reduced weight matrix by the first reduced matrix and the second reduced matrix to perform quantization.

20. A non-transitory computer-readable medium having machine-readable instructions stored thereon, which when executed by a processor, cause the processor to:
determine a weight matrix having a first dimension and a second dimension;
eliminate elements of the weight matrix by singular value decomposition to produce a reduced weight matrix of a third dimension by the third dimension;
determine a first reduced matrix of the first dimension and the third dimension;
determine a second reduced matrix of the second dimension and the third dimension; and
multiply the reduced weight matrix by the first reduced matrix and the second reduced matrix to solve the weight matrix.
